(19) United States
(12) Patent Application Publication
(10) Pub. No.: US 2016/0026756 A1
(43) Pub. Date: Jan. 28, 2016

(54) METHOD AND APPARATUS FOR SEPARATING QUALITY LEVELS IN SEQUENCE DATA AND SEQUENCING LONGER READS

(71) Applicant: OriGenome, LLC, Johnston, IA (US)

(72) Inventor: Tongbin LI, Johnston, IA (US)

(21) Appl. No.: 14/358,620

(22) PCT Filed: Feb. 13, 2014
(86) PCT No.: PCT/CN2014/072030

§ 371 Date: May 15, 2014

Related U.S. Application Data
(60) Provisional application No. 61/898,650, filed on Nov. 1, 2013.

(51) Int. Cl. G06F 19/22; G06F 19/28; G06F 19/24

(52) U.S. Cl. CPC G06F 19/22; G06F 19/24; G06F 19/28

(57) ABSTRACT

Sequencing reads from a measurement system may be classified based on quality scores associated with the measurement system, and corresponding error characteristics may be provided. The sequencing reads may correspond to at least one of deoxyribonucleic acid (DNA), complementary DNA (cDNA), or ribonucleic acid (RNA).

### CROSS-REFERENCE TO RELATED APPLICATIONS

This application is a U.S. National Stage Application under 35 U.S.C. §371 of PCT/CN2014/072030, filed on Feb. 13, 2014, which claims the benefit of U.S. Provisional Application No. 61/898,650, filed Nov. 1, 2013, which is incorporated herein by reference in its entirety.

### FIELD

The present disclosure relates generally to nucleotide data and more particularly to data processing for nucleotide data and to instruments and devices through which nucleotide data are acquired.

### BACKGROUND

Applications related to measurements of nucleotide data have been limited by the accuracy of the measurements and by the relatively short read lengths available through conventional sequencing technologies. Thus, there is a need for improved methods and related systems for characterizing accuracy and achieving higher accuracy for sequences of nucleotide data and for achieving longer reads without compromising accuracy.

### BRIEF DESCRIPTION OF DRAWINGS

Some embodiments are illustrated by way of example and not limitation in the figures of the accompanying drawings.

FIG. 1 is a diagram that shows sequence elements related to the embodiments presented herein.

FIG. 2 is a diagram that shows an error profile related to embodiments presented here.

FIG. 3 is a flowchart that shows a method of processing sequencing reads according to an example embodiment.

FIG. 4 is another diagram that shows an error profile related to embodiments presented here.

FIG. 5 is another diagram that shows an error profile related to embodiments presented here.

FIGS. 6A and 6B are diagrams that show multiple error profiles related to embodiments presented here.

FIG. 7 shows a method of using sequencing reads for an example embodiment.

FIG. 8 is a block diagram that shows a schematic representation of an apparatus for an example embodiment.

FIG. 9 is a block diagram that shows a computer processing system within which a set of instructions for causing the computer to perform any one of the methodologies discussed herein may be executed.

### DETAILED DESCRIPTION

### 1. Background

With the development of technologies related to sequencing nucleotides (A, C, T, G), next-generation sequencing (NGS) has become an increasingly active area due to the need for increased throughput. Conventional NGS technologies have been developed by ILLUMINA as well as ION TORRENT, PACIFIC BIOSCIENCES, and a few other entities. In the discussion below, ILLUMINA's technology is taken as a reference point for conventional NGS sequencing platforms and related NGS data. However, embodiments presented herein may be applied generally to NGS sequencing platforms with related functionality.

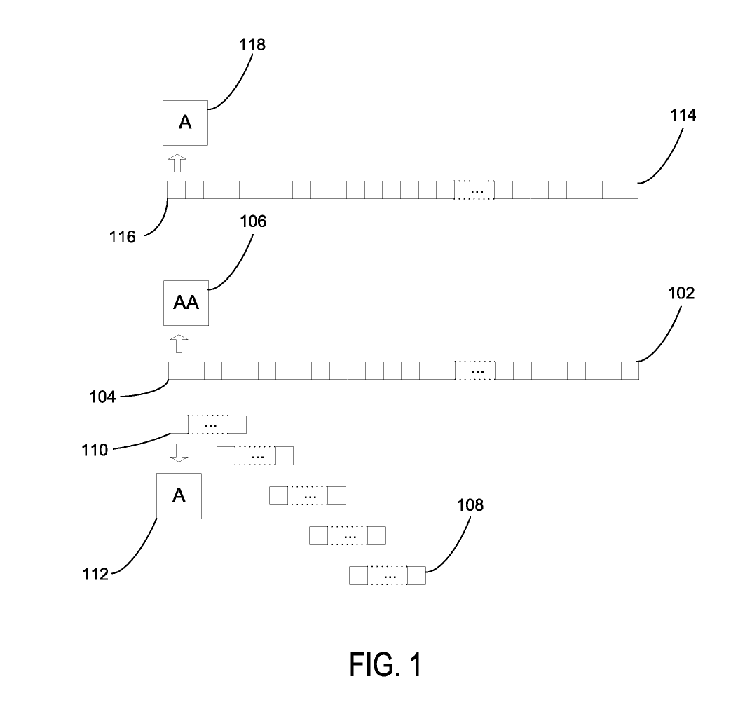

FIG. 1 is a diagram that shows sequence elements related to the embodiments presented herein. A target sequence 102 for a diploid subject includes a sequence of diploid nucleotides (e.g., AA, CC, GG, TT, AC, AG, AT, CG, CT, GT), where the first element 104 includes the base values AA as shown at block 106. A number of sequencing reads 108 (e.g., from an NGS platform) are also shown, where a first element 110 of a first one of the sequencing reads 108 includes the base value A as shown at block 112. The length of the target sequence 102 may be arbitrarily long (e.g., 3-4 billion base values for the human genome). The lengths of the sequencing reads 108 is also arbitrary but is typically much smaller (e.g., 50-150 base values for NGS technology). As will be appreciated by one skilled in the art, the relative alignments of the target sequence 102 and the sequencing reads 108 is illustrated by the horizontal axis in FIG. 1, so that each entry of the target sequence 102 or one of the sequencing reads 214 corresponds to a location of the reference sequence 202. Typically this alignment is carried out with respect to a reference sequence 114 (e.g., a published sequence). As shown in FIG. 1, the first element 116 of the reference sequence 114 includes the base values AA as shown at block 118.

Some NGS technology (e.g., from ILLUMINA) can be described as a sequencing-by-synthesis (SBS)-based sequencing platform. SBS technologies are characterized by a flexible and simple workflow, which produces a large quantity of sequence reads in parallel. This massively parallel sequencing system is based on the use of “DNA Clusters”, which involve the clonal amplification of DNA on a surface. In order to determine the sequence in the sample, four types of reversible terminator bases are added and non-incorporated nucleotides are washed away. A camera takes images of the fluorescently labeled nucleotides. Then the dye, along with the terminal 3′ blocker, is removed from the DNA, and the next cycle begins. In some NGS technologies commonly referred to as third-generation and fourth-generation sequencing technologies, electronic signals or changes in pH levels are detected and measured rather than optical signals. Embodiments described in this disclosure are equally applicable to NGS technologies regardless of the signal type (e.g., optical, electronic, pH level).

In addition to SBS-based sequencing platforms, alternative approaches to NGS technology with related functionality include, for example, sequencing-by-ligation (SBL) platforms.

As compared to the first-generation sequencing technology, NGS technology typically has the advantage of a much higher throughput and a much lower cost when equal amounts of data are considered. However, there are typically also disadvantages related to shorter read lengths and higher error rates.

The NGS read length is typically much shorter compared to the earlier technologies (e.g., 27-250 nucleotides for NGS vs. ˜1000-2000 nucleotides for first-generation, Sanger-based sequencing). This may be problematic for several reasons: (A) It is considerably more difficult to map/align shorter reads precisely to the reference genome—considering the very big reference genome (e.g., the human genome is 3-4 billion bases long). (B) The reference genome often contains many repeated regions—in fact more than a half of the human reference genome is covered by repeated elements. Some of the most important repeated regions are on the level of ˜200 nucleotides or longer. The read length limitation makes it very difficult for important repeats to be studied. (C) For de novo genome sequencing, that is, the sequencing of the genome of a species whose reference genome is not yet available, mapping-based analysis is generally not applicable, and assembly-based methods have to be applied (the purpose of which is to “create” a reference genome from the read data). The short read lengths present additional challenges for these methods in species (e.g., plant species) whose reference genomes are very large and contain many repeated regions. (D) For applications where long sequences of nucleotides are needed, the shorter read lengths present additional challenges. For example, bone marrow typing for identifying proper donors for bone marrow transplants typically requires sequencing lengths of at least 500 nucleotides.

The higher error rates associated with NGS technology present additional challenges. For example, depending on the operational setting, the NGS error rate may be on the order of 1%, as compared with nominal error rates of about 0.001-0.1% reported for first-generation (or Sanger) sequencing. This disadvantage makes it difficult to do accurate calling of single-nucleotide variations (SNVs) and other variants. Related embodiments may be used for SNV calling with different quality levels as described in the related U.S. provisional patent application “METHOD AND APPARATUS FOR CALLING SINGLE-NUCLEOTIDE VARIATIONS,” No. 61/898,680, filed Nov. 1, 2013, and which is incorporated herein by reference in its entirety, and related PCT application “METHOD AND APPARATUS FOR CALLING SINGLE-NUCLEOTIDE VARIATIONS AND OTHER VARIATIONS,” which is filed on the same date as the present application by an overlapping inventive entity, and which is incorporated herein by reference in its entirety.

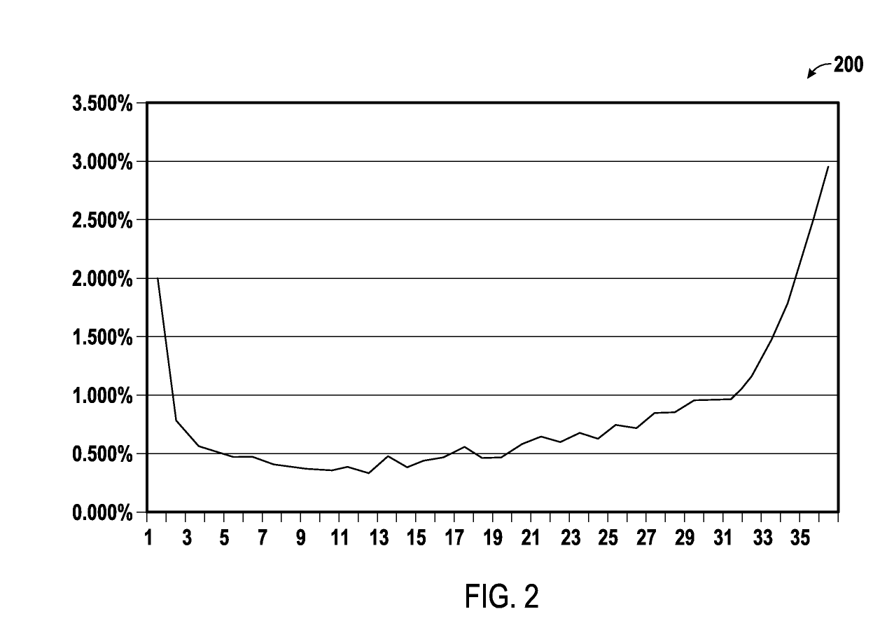

Existing error profiling analysis of NGS data has typically been conducted in a position-centric manner; that is, researchers have looked at the position as the most informative independent variable, pooled many reads together (after they are all aligned to the reference sequence), and calculated the proportion of errors occurring at each position within the read. These studies have resulted in error profiles similar to the one shown in FIG. 2. FIG. 2 shows an example error profile 200 where the horizontal axis is an index of positions within the read, and vertical axis shows the error rate for the empirically derived error profile 200. (Error profiles with similar representations are shown for embodiments below.) As shown in FIG. 2, at the beginning of the read on the 5′ end (i.e., the left-hand side), the error goes slightly higher, then it drops and remains somewhat in the middle section of the read, at a rate around 0.5-1%. Towards the 3′ end (i.e., the right-hand side of the read), the error rate drastically goes up, to levels much higher than 1%. The overall error rate (across all positions) is about 1%. It should be noted that the read lengths used in these examples (e.g., 36-50) are for illustrative purposes only and higher read lengths (e.g., ˜100 or longer) may also be used.

### 2. Method Embodiment

Example methods and systems are directed to data processing for nucleotide data. The disclosed examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

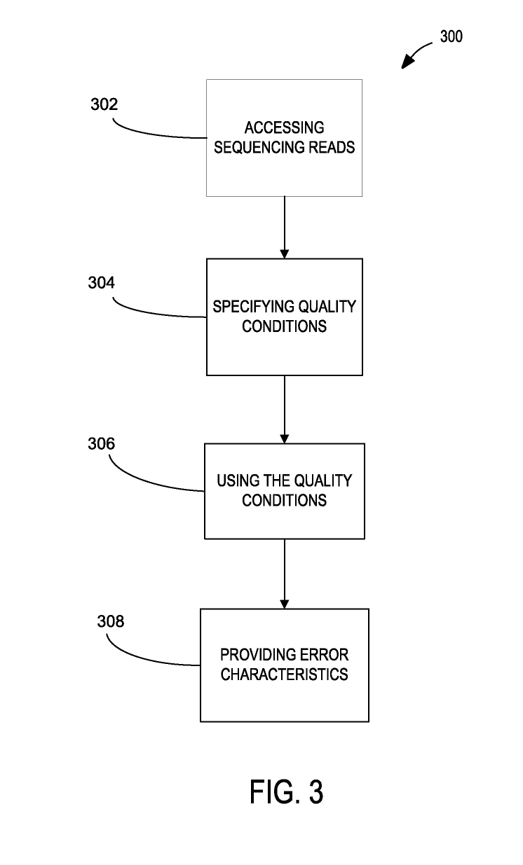

FIG. 3 shows a method 300 of processing sequencing reads according to an example embodiment. A first operation 302 includes accessing a plurality of sequencing reads associated with a measurement system, each sequencing read including a sequence of base values, and one or more locations of each sequencing read being associated with a quality score that characterizes operations of the measurement system at the one or more locations. The measurement system may be a genomic measurement system that produces sequencing reads corresponding to deoxyribonucleic acid (DNA). However, other measurement systems are possible, and the sequencing reads may correspond to at least one of DNA, complementary DNA (cDNA), or ribonucleic acid (RNA).

As discussed above, the quality score may correspond to a Phred score associated with the measurement system. However alternative characterizations of measurement quality may be used. For example, the quality score at a given location may characterize signal intensity relative to signal intensities nearby locations.

A second operation 304 includes specifying one or more quality conditions based on values of the quality score. The quality conditions may correspond to applying at least one threshold value to values of the quality score (e.g., based on inequality bounds on the quality scores).

A third operation 306 includes using the one or more quality conditions to specify one or more quality classifications for the sequencing reads, each quality classification being based on satisfying at least one corresponding quality condition at locations of the sequencing reads, a given sequencing read having a given quality classification satisfies the corresponding one or more quality conditions uniformly across locations in the given sequencing read.

This embodiment may be understood as a “read-centric” approach to analyzing the error profiles of the conventional data. That is, the read in which a position belongs may be considered as to be a more informative independent variable (than the position). For example, because a read corresponds to the sequencing reaction occurring in a single cluster on the flow cell of the NGS sequencer, factors such as template molecule imperfection, amplification artifacts and interference from neighboring clusters may lead to errors that exhibit strong read-specific characteristics. In accordance with one embodiment for the read-centric approach, we classified the reads into two categories based on the minimal Phred score of all positions within the read, and then we look at the error profiles of each category separately. The “default” Phred score cut-off is 15, that is, we categorize all reads for which the minimal Phred score of all positions is >15 to be high-quality reads, and those other reads are categorized as low-quality reads. Note, some of the “low-quality reads” may have many positions that are of very high Phred score (or good quality), e.g., a 36-nucleotide read may have 35 of the 36 positions having a Phred score of 30, but the single remaining position has a Phred score of 14—this read will be categorized as a low-quality read. (It should be noted that the Phred score is well known to those skilled in the art as a characterization of sequence quality obtained from a sequencing system.)

A fourth operation 308 providing an error characteristic corresponding to each quality classification. For example, the error characteristic may include an estimated error corresponding to the measurement system across a portion of a corresponding sequencing read. The error characteristic may include an estimated error corresponding to the measurement system across a portion of a corresponding sequencing read.

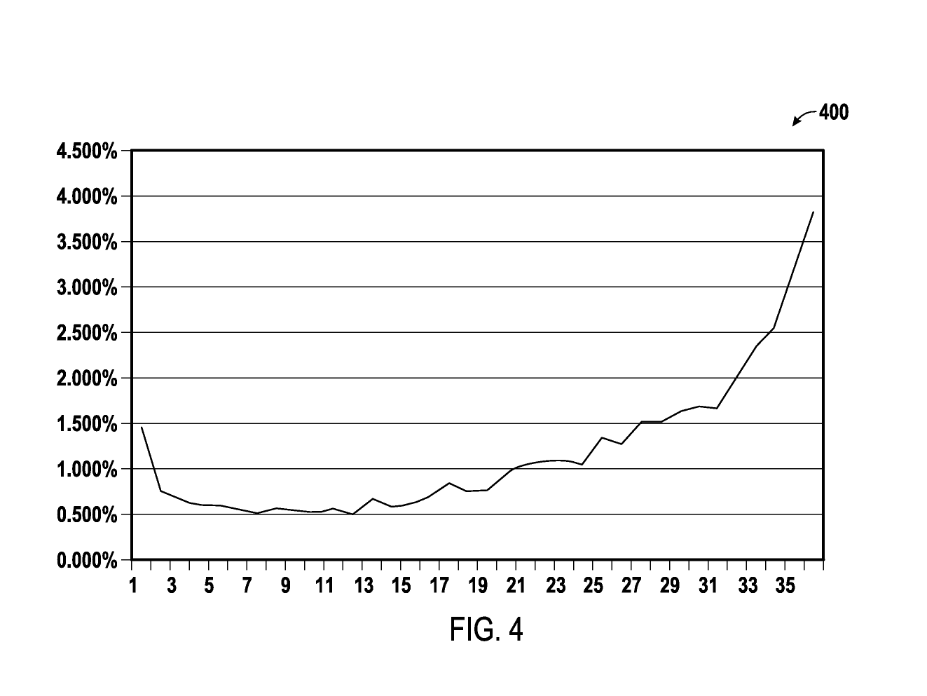

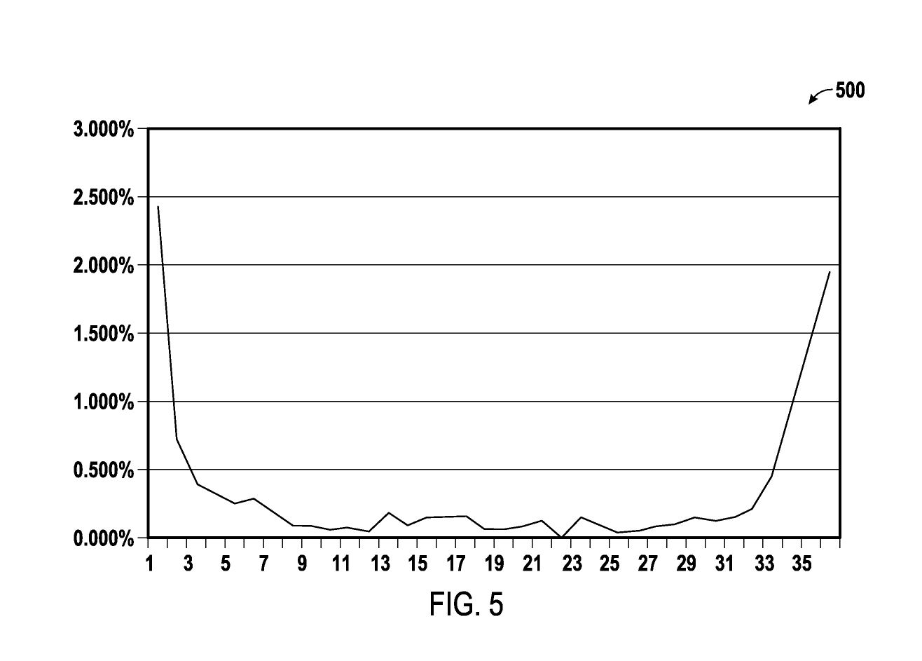

For the example embodiment described above with two quality classifications based on Phred scores, low-quality reads have an error profile 400 as shown in FIG. 4, and the high-quality reads have an error profile 500 as shown in FIG. 5. The error profile 400 of FIG. 4 similar to the “prototypical” error profile 200 shown in FIG. 2. However, the error profile 500 of high-quality reads shows a quasi-symmetric pattern. That is, for ˜7 positions at each of the two ends of the read, the error rate shoots up in an almost symmetric manner (in contrast to the very asymmetric shape in the prototypical error profile 200 of FIG. 2). Other than these two narrow ends, the majority of the positions in the read (e.g., in the middle session) show a very low error rate of 0.1%, which is one order of magnitude lower than the nominal error rate for an NGS platform as shown in FIG. 2. Furthermore, this rate (0.1%) is at the same level as the nominal human SNV rate.

It should be noted that the existence of multiple quality levels in existing sequence data is not conventionally understood or appreciated. An appreciation of the discovery that certain NGS sequencing reads are a mixture of two sub-populations enables sequencing operations with much longer reads but without higher errors. That is, one may use the measurement system to analyze a target sequence and to provide sequencing reads with increasing length values.

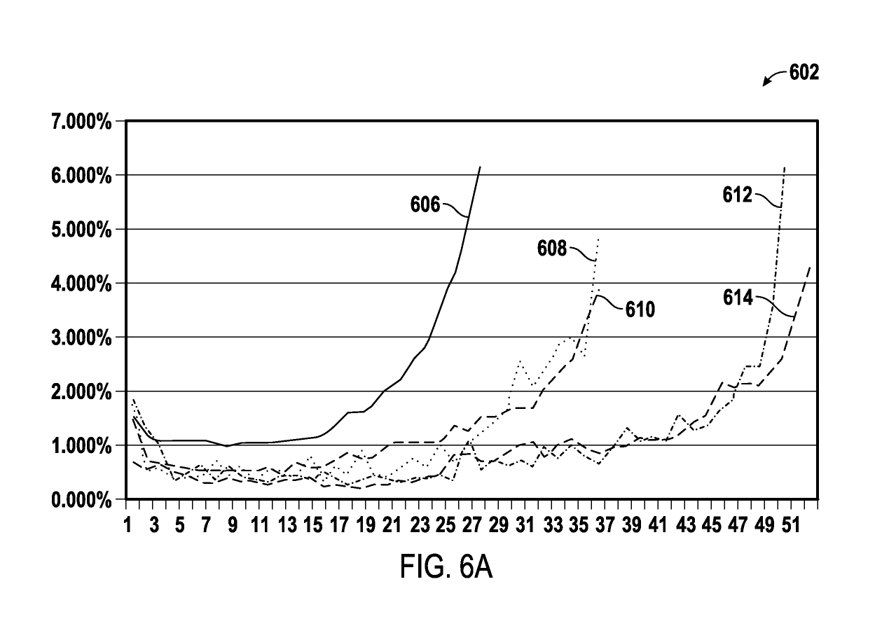

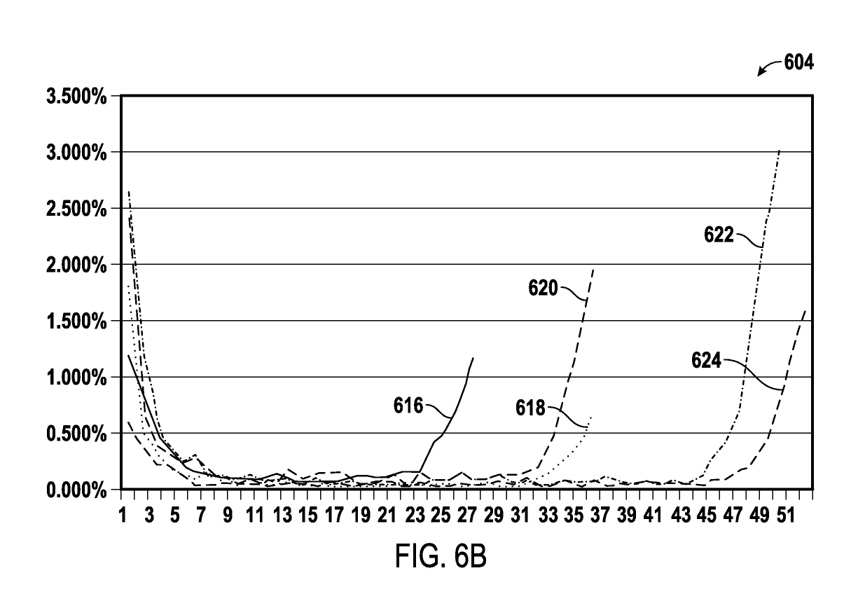

FIGS. 6A-6B show related error profiles 602, 604 for additional datasets with the same definitions for high-quality and low-quality reads but with varying read lengths. FIG. 6A shows error profiles 602 of the low-quality reads for five datasets, and FIG. 6B shows the corresponding error profiles 604 for the high-quality reads from the datasets. That is, low-quality error profiles 606, 608, 610, 612, 614 in FIG. 6A correspond respectfully to high-quality error profiles 616, 618, 620, 622, 624 in FIG. 6B. Notably, the error profiles 602 in FIG. 6A are qualitatively similar to the error profile 400 in FIG. 4, and the error profiles 604 in FIG. 6B are qualitatively similar to the error profile 500 in FIG. 5. It should be noted that (a) the widths of the two ends of the error profiles 604 for high-quality reads (that is, the two regions whose error level shoots up) are consistently ˜7 nucleotides, and (b) the middle sections (after the 7 nucleotides on both ends are removed) consistently have a very low error rate that is about 0.1%. What this suggests for related embodiments is that, for increasingly large read lengths (e.g., up to 150 in some embodiments), after we remove a boundary of base values from each end (˜7 nucleotides), what remains is some very high-quality sequencing data. This discovery enables a way to extract a proportion (about 50%) of data that possesses much higher quality than commonly believed for conventional NGS sequencing platforms, with an error rate low enough to be comparable with some of the data generated from first-generation sequencing platforms.

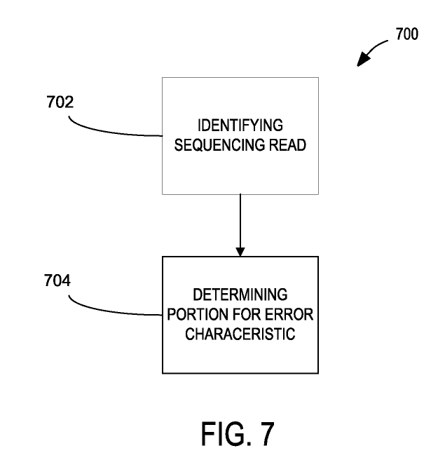

FIG. 7 shows a related method 700 of using sequencing reads (e.g., with longer read lengths). A first operation 702 includes identifying a given sequencing read having a given quality classification with a given error characteristic. A second operation 704 includes determining a portion of the given sequencing read where the given error characteristic includes a uniform bound on estimated error corresponding to the measurement system across the portion of the given sequencing read. That is, for the embodiments of FIG. 6B, the portion may refer to the middle section of the sequencing read (e.g., after deleting ˜7 nucleotides on each end), and the given error characteristic may be a uniform bound of about 0.1% (or some other empirically determined value).

A conventional NGS sequencing platform puts a limit to its read length at 150 or 250 (varying with the sequencer models). There is conventionally no incentive to make even longer reads, because when one looks at the prototypical error profile (e.g., FIG. 2), their error rate skyrockets at the 3′ end. Further increasing read length will lead to substantial downgrading of their data's quality. Through the read-centric approach, however, certain embodiments enable the extraction of a proportion of the read data (which may account for about a half of all reads)—the high-quality reads, that have an error rate of 0.1-0.15%, after a few bases are removed from each side. This offers an incentive to make even longer reads using a conventional NGS sequencing platform.

In accordance with certain embodiments, a conventional NGS sequencing platform can be used to sequence reads longer than the limit imposed by current platforms, to the level of 2000 bases or even longer. This is followed by the extraction of the high-quality reads as discussed above. Then, for example, the low-quality reads may be discarded or possibly used under some circumstances. The ability to extract high-quality reads, in effect, removes one major obstacle for conventional NGS sequencing platforms to generate longer reads with a low enough error rate to be practically useful. These embodiments enable accurate longer read sequencing using established and relatively inexpensive sequencing platforms.

It should be noted that although the embodiments described above employ a Phred quality score as the quality measure of the base calls, other characterizations of sequence quality may be used similarly. These quality characterizations may include characterizations summarized from the sequencing experiments, from images produced by the sequencing instruments, and from the nucleotide sequences that are known to be associated with, and thus are indicative of, the quality of the base calls. For example, these quality characterizations may be based on combinations of characteristics such as the cycle number, sequence motifs, measurements of signal-to-noise ratio of intensities for current, previous or following cycle(s), and so-called “trace parameters.” (Ewing et al., “Base-calling of automated sequencer traces using phred. 1. Accuracy assessment.” Genome Research, 1998, 8: 175-185. Ewing and Green, “Base-calling of automated sequencer traces using phred. 11. Error probabilities.” Genome Research, 1998, 8:186-194.) As discussed above, related embodiments enable an evaluation of the quality of the read as a whole through an overall quality evaluation of the bases within a read.

### 3. Additional Embodiments

Additional embodiments correspond to systems and related computer programs that carry out the above-described methods.

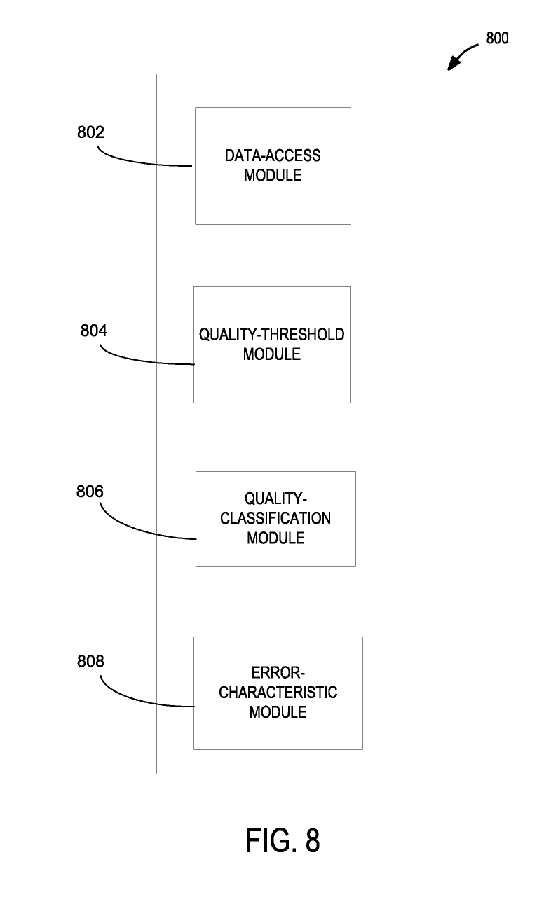

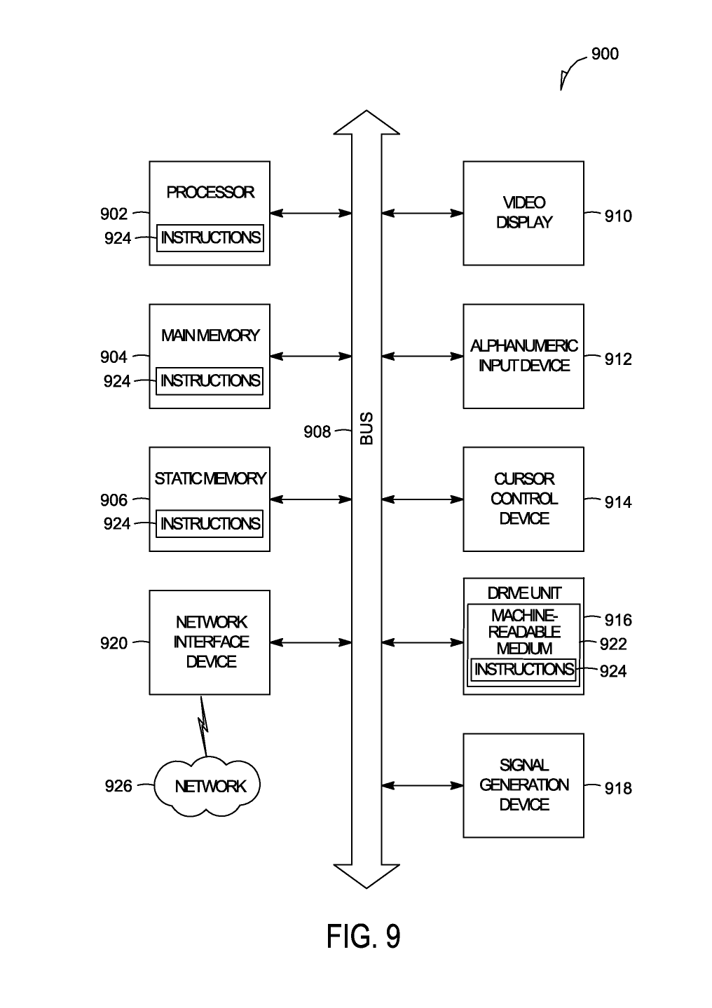

FIG. 8 shows a schematic representation of an apparatus 800, in accordance with an example embodiment to process sequencing reads. In this case, the apparatus 800 includes at least one computer system (e.g., as in FIG. 9) to perform software and hardware operations for modules that carry out aspects of the method 300 of FIG. 3.

In accordance with an example embodiment, the apparatus 800 includes a data-access module 802, a quality-threshold module 804, a quality-classification module 806, and an error-characteristic module 808.

The data-access module 802 operates to access a plurality of sequencing reads associated with a measurement system, each sequencing read including a sequence of base values, and one or more locations of each sequencing read being associated with a quality score that characterizes operations of the measurement system at the one or more locations. The quality-threshold module 804 operates to specify one or more quality conditions based on values of the quality score. The quality-classification module 806 operates to use the one or more quality conditions to specify one or more quality classifications for the sequencing reads, each quality classification being based on satisfying at least one corresponding quality condition at locations of the sequencing reads. The error-characteristic module 808 operates to provide an error characteristic corresponding to each quality classification. Additional operations related to the method 300 may be performed by additional corresponding modules or through modifications of the above-described modules.

FIG. 9 shows a machine in the example form of a computer system 900 within which instructions for causing the machine to perform any one or more of the methodologies discussed here may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904, and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) cursor control device 914 (e.g., a mouse), a disk drive unit 916, a signal generation device 918 (e.g., a speaker), and a network interface device 920.

In some contexts, a computer-readable medium may be described as a machine-readable medium. The disk drive unit 916 includes a machine-readable medium 922 on which is stored one or more sets of data structures and instructions 924 (e.g., software) embodying or utilizing any one or more of the methodologies or functions described herein. The instructions 924 may also reside, completely or at least partially, within the static memory 906, within the main memory 904, or within the processor 902 during execution thereof by the computer system 900, with the static memory 906, the main memory 904, and the processor 902 also constituting machine-readable media.

While the machine-readable medium 922 is shown in an example embodiment to be a single medium, the terms “machine-readable medium” and “computer-readable medium” may each refer to a single medium or multiple media (e.g., a centralized or distributed database, and/or associated caches and servers) that store the one or more sets of data structures and instructions 924. These terms shall also be taken to include any tangible or non-transitory medium that is capable of storing, encoding or carrying instructions for execution by the machine and that cause the machine to perform any one or more of the methodologies disclosed herein, or that is capable of storing, encoding or carrying data structures utilized by or associated with such instructions. These terms shall accordingly be taken to include, but not be limited to, solid-state memories, optical media, and magnetic media. Specific examples of machine-readable or computer-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; compact disc read-only memory (CD-ROM) and digital versatile disc read-only memory (DVD-ROM).

The instructions 924 may further be transmitted or received over a communications network 926 using a transmission medium. The instructions 924 may be transmitted using the network interface device 920 and any one of a number of well-known transfer protocols (e.g., hypertext transfer protocol (HTTP)). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Certain embodiments are described herein as including logic or a number of components, modules, or mechanisms. Modules may constitute either software modules or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module (e.g., a computer-implemented module) may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” (e.g., a “computer-implemented module”) should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

### 4. Conclusion

Although only certain embodiments have been described in detail above, those skilled in the art will readily appreciate that many modifications are possible without materially departing from the novel teachings of this disclosure. For example, aspects of embodiments disclosed above can be combined in other combinations to form additional embodiments. Accordingly, all such modifications are intended to be included within the scope of this disclosure.

What is claimed is:

1. A method of processing sequencing reads, the method comprising:
accessing a plurality of sequencing reads associated with a measurement system, each sequencing read including a sequence of base values, and one or more locations of each sequencing read being associated with a quality score that characterizes operations of the measurement system at the one or more locations;
specifying one or more quality conditions based on values of the quality score;
using the one or more quality conditions to specify one or more quality classifications for the sequencing reads, each quality classification being based on satisfying at least one corresponding quality condition at locations of the sequencing reads; and
providing an error characteristic corresponding to each quality classification.

2. The method of claim 1, wherein a given sequencing read having a given quality classification satisfies the corresponding one or more quality conditions uniformly across locations in the given sequencing read.

3. The method of claim 1, wherein each error characteristic includes an estimated error corresponding to the measurement system across a portion of a corresponding sequencing read.

4. The method of claim 1, wherein each quality condition corresponds to applying at least one threshold value to values of the quality score.

5. The method of claim 1, wherein the quality score corresponds to a Phred score.

6. The method of claim 1, wherein a quality score at a given location characterizes a signal intensity relative to signal intensities nearby locations.

7. The method of claim 1, wherein the measurement system is a genomic measurement system.

8. The method of claim 1, wherein the sequencing reads correspond to at least one of deoxyribonucleic acid (DNA), complementary DNA (cDNA), or ribonucleic acid (RNA).

9. The method of claim 1, further comprising:
identifying a given sequencing read having a given quality classification with a given error characteristic; and
determining a portion of the given sequencing read where the given error characteristic includes a uniform bound on estimated error corresponding to the measurement system across the portion of the given sequencing read.

10. The method of claim 1, further comprising:
providing the sequencing reads by using the measurement system to analyze a target sequence with increasing values for lengths of the sequencing reads.

11. A non-transitory computer-readable medium that stores a computer program for processing sequencing reads, the computer program including instructions that, when executed by at least one computer, cause the at least one computer to perform operations comprising:
accessing a plurality of sequencing reads associated with a measurement system, each sequencing read including a sequence of base values, and one or more locations of each sequencing read being associated with a quality score that characterizes operations of the measurement system at the one or more locations;
specifying one or more quality conditions based on values of the quality score;
using the one or more quality conditions to specify one or more quality classifications for the sequencing reads, each quality classification being based on satisfying at least one corresponding quality condition at locations of the sequencing reads; and
providing an error characteristic corresponding to each quality classification.

12. The non-transitory computer-readable medium of claim 11, wherein a given sequencing read having a given quality classification satisfies the corresponding one or more quality conditions uniformly across locations in the given sequencing read.

13. The non-transitory computer-readable medium of claim 11, wherein each error characteristic includes an estimated error corresponding to the measurement system across a portion of a corresponding sequencing read.

14. The non-transitory computer-readable medium of claim 11, wherein each quality condition corresponds to applying at least one threshold value to values of the quality score.

15. The non-transitory computer-readable medium of claim 11, wherein the quality score corresponds to a Phred score.

16. The non-transitory computer-readable medium of claim 11, wherein a quality score at a given location characterizes a signal intensity relative to signal intensities nearby locations.

17. The non-transitory computer-readable medium of claim 11, wherein the sequencing reads correspond to at least one of deoxyribonucleic acid (DNA), complementary DNA (cDNA), or ribonucleic acid (RNA).

18. The non-transitory computer-readable medium of claim 11, wherein the computer program further includes instructions that, when executed by the at least one computer, cause the at least one computer to perform operations comprising:
identifying a given sequencing read having a given quality classification with a given error characteristic; and
determining a portion of the given sequencing read where the given error characteristic includes a uniform bound on estimated error corresponding to the measurement system across the portion of the given sequencing read.

19. The non-transitory computer-readable medium of claim 11, wherein the computer program further includes instructions that, when executed by the at least one computer, cause the at least one computer to perform operations comprising:
providing the sequencing reads by using the measurement system to analyze a target sequence with increasing values for lengths of the sequencing reads.

20. An apparatus to process sequencing reads, the apparatus comprising at least one computer configured to perform operations for computer-implemented modules including:
a data-access module to access a plurality of sequencing reads associated with a measurement system, each sequencing read including a sequence of base values, and one or more locations of each sequencing read being associated with a quality score that characterizes operations of the measurement system at the one or more locations;
a quality-threshold module to specify one or more quality conditions based on values of the quality score;
a quality-classification module to use the one or more quality conditions to specify one or more quality classifications for the sequencing reads, each quality classification being based on satisfying at least one corresponding quality condition at locations of the sequencing reads; and
an error-characteristic module to provide an error characteristic corresponding to each quality classification.
